(19) United States
(12) Patent Application Publication
(10) Pub. No.: US 2026/0011507 A1
(43) Pub. Date: Jan. 8, 2026

(54) LAMINATED CERAMIC CAPACITOR AND METHOD OF MANUFACTURING LAMINATED CERAMIC CAPACITOR

(71) Applicant: TAIYO YUDEN CO., LTD., Tokyo (JP)

(72) Inventor: Wakaaki MURAI, Tokyo (JP)

(21) Appl. No.: 19/329,384

(22) Filed: Sep. 15, 2025

Related U.S. Application Data
(63) Continuation of application No. PCT/JP2024/003770, filed on Feb. 5, 2024.

(30) Foreign Application Priority Data
Mar. 16, 2023 (JP) 2023-042418

(51) Int. Cl. H01G 4/30; H01G 4/012; H01G 4/232

(52) U.S. Cl. CPC H01G 4/30; H01G 4/012; H01G 4/232

(57) ABSTRACT

An aspect of the present invention provides a laminated ceramic capacitor including a body, a first external electrode, and a second external electrode. The body includes a first internal electrode layer, a second internal electrode layer and a dielectric layer. The first and second internal electrode layers are principally formed of Ni. The dielectric layer is disposed between the first internal electrode layer and the second internal electrode layer. The first and second external electrodes are provided on the body so as to be electrically connected to the first and second internal electrode layers, respectively. The first internal electrode layer includes a first region and a second region. The second region has a lower Ni concentration than the first region. The second region has a higher Fe concentration than the first region. The second region has a higher O concentration than the first region.

### CROSS-REFERENCE TO RELATED APPLICATIONS

This is a continuation application of a PCT application No. PCT/JP2024/3770 filed on Feb. 5, 2024, which is based on and claims the benefit of priority from Japanese patent Application serial No. 2023-042418 (filed on Mar. 16, 2023). The contents of the PCT and Japanese applications are hereby incorporated by reference in their entirety.

### TECHNICAL FIELD

The disclosure herein relates mainly to a laminated ceramic capacitor and a method of manufacturing the laminated ceramic capacitor. The disclosure herein also relates to a circuit module with the laminated ceramic capacitor and an electronic device with the circuit module.

### BACKGROUND

Laminated ceramic capacitors are installed in various electronic devices.

Laminated ceramic capacitors have dielectric layers and internal electrode layers that are stacked on each other. Laminated ceramic capacitors are made by firing laminates consisting of dielectric green sheets and internal electrode patterns, which are respectively the precursors of the dielectric layers and the internal electrode layers.

During the manufacturing process of laminated ceramic capacitors, Ni, the main component of the internal electrode layers, may be oxidized to generate insulating nickel oxide (NiO) in the internal electrode layers. The region of the internal electrode layers where a large amount of nickel oxide is generated does not contribute to the generation of capacitance. This may cause a decrease in the capacitance of the laminated ceramic capacitors.

### SUMMARY

It is an object of the present disclosure to solve or alleviate at least part of the drawback mentioned above. Particularly, it is an object of the present disclosure to prevent a decrease in capacitance of laminated ceramic capacitors that is attributable to oxidation of elements contained in the internal electrode layers.

The various inventions disclosed herein may be collectively referred to as “the invention”. Other objects of the disclosure will be made apparent through the entire description in the specification. The invention disclosed herein may also address drawbacks other than that grasped from the above description. When an advantageous effect of an embodiment is described herein, the advantageous effect suggests an object of the invention corresponding to the embodiment.

An aspect of the present disclosure includes a laminated ceramic capacitor including a body, a first external electrode, and a second external electrode. In one aspect, the body includes a first internal electrode layer, a second internal electrode layer and a dielectric layer. The first and second internal electrode layers are principally formed of Ni. The dielectric layer is disposed between the first internal electrode layer and the second internal electrode layer. The first external electrode is provided on the body so as to be electrically connected to the first internal electrode layer. The second external electrode is provided on the body so as to be electrically connected to the second internal electrode layer. In one aspect, the first internal electrode layer includes a first region and a second region. The second region has a lower Ni concentration than the first region. In one aspect, the second region has a higher Fe concentration than the first region. In one aspect, the second region has a higher O concentration than the first region.

### Advantageous Effects

One embodiment of the present disclosure can prevent a decrease in capacitance of laminated ceramic capacitors that is attributable to oxidation of elements contained in the internal electrode layers.

### BRIEF DESCRIPTION OF THE DRAWINGS

FIG. 1 is a perspective view schematically showing a laminated ceramic capacitor according to one embodiment of the disclosure.

FIG. 2 is a sectional view schematically showing a section of the laminated ceramic capacitor of FIG. 1 along the line I-I.

FIG. 3A is an enlarged sectional view schematically showing nickel (Ni) distribution in a region A of the section shown in FIG. 2.

FIG. 3B is an enlarged sectional view schematically showing oxygen (O) distribution in the region A of the section shown in FIG. 2.

FIG. 3C is an enlarged sectional view schematically showing iron (Fe) distribution in the region A of the section shown in FIG. 2.

FIG. 4 is a flowchart showing a flow of a manufacturing method of a laminated ceramic capacitor according to one embodiment of the disclosure.

### DESCRIPTION OF THE PREFERRED EMBODIMENTS

Various embodiments of the disclosure will be described hereinafter with reference to the appended drawings. Throughout the drawings, the same components are denoted by the same or like reference numerals. For convenience of explanation, the drawings are not necessarily drawn to scale. The following embodiments of the disclosure do not limit the scope of the claims. The elements included in the following embodiments are not necessarily essential to solve the problem addressed by the invention.

For convenience of explanation, each of the drawings may show the L axis, the W axis, and the T axis orthogonal to one another. In this specification, the dimensions, arrangement, shape, and other features of each component of a laminated ceramic capacitor 1 may be described with reference to the L, W, and T axes.

### (1) Laminated Ceramic Capacitor 1

### (1-1) Basic Structure of Laminated Ceramic Capacitor 1

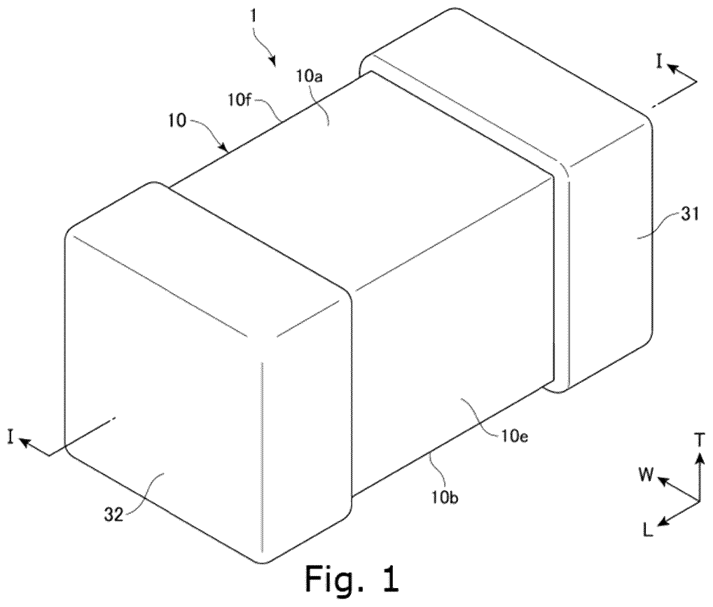

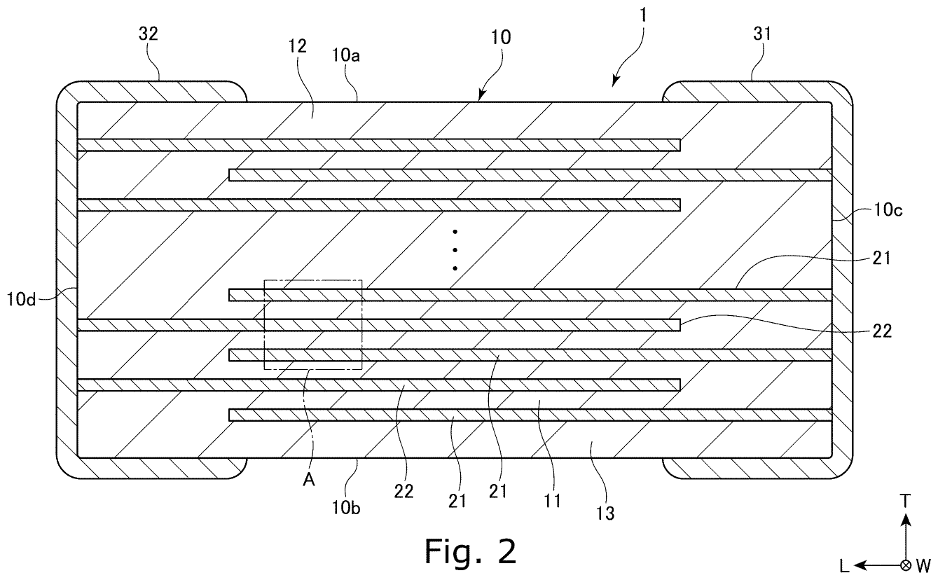

Referring to FIGS. 1 and 2, a description will now be given of the basic structure of a laminated ceramic capacitor 1 according to a first embodiment FIG. 1 is a perspective view showing the laminated ceramic capacitor 1 according to the first embodiment FIG. 2 is a sectional view schematically showing a section of the laminated ceramic capacitor 1 along the line I-I.

The laminated ceramic capacitor 1 has a body 10, and a first external electrode 31 and a second external electrode 32 provided on the body 10. The first external electrode 31 is spaced apart from the second external electrode 32. In the example shown in FIG. 2, the first external electrode 31 is spaced apart from the second external electrode 32 in the L-axis direction.

The body 10 has a top surface 10a, a bottom surface 10b, a first end surface 10c, a second end surface 10d, a first side surface 10e, and a second side surface 10f. The outer surface of the body 10 is defined by the top surface 10a, the bottom surface 10b, the first end surface 10c, the second end surface 10d, the first side surface 10e, and the second side surface 10f.

The top surface 10a and the bottom surface 10b form the opposite ends of the body 10 in the height direction (T-axis direction). In other words, the top surface 10a and the bottom surface 10b are opposed to each other in the T-axis direction. The first end surface 10c and the second end surface 10d form the opposite ends of the body 10 in the length direction (L-axis direction). In other words, the first end surface 10c and the second end surface 10d are opposed to each other in the L-axis direction. The first side surface 10e and the second side surface 10f form the opposite ends of the body 10 in the width direction (W-axis direction). In other words, the first side surface 10e and the second side surface 10f are opposed to each other in the W-axis direction. The top surface 10a and the bottom surface 10b are separated from each other by a distance equal to the height of the body 10, the first end surface 10c and the second end surface 10d are separated from each other by a distance equal to the length of the body 10, and the first side surface 10e and the second side surface 10f are separated from each other by a distance equal to the width of the body 10.

The body 10 includes a plurality of dielectric layers 11, a plurality of first internal electrode layers 21, and a plurality of second internal electrode layers 22. The dielectric layers 11, the first internal electrode layers 21, and the second internal electrode layers 22 are stacked together along the lamination direction. In the illustrated embodiment, the dielectric layers 11, the first internal electrode layers 21, and the second internal electrode layers 22 are stacked together along the T-axis direction. The lamination direction may be along the T axis, as shown in the drawings, or may be along the L or W axis. The dielectric layers 11 located at the opposite ends in the lamination direction may be referred to as cover layers.

A dielectric layer 11 is present between a first internal electrode layer 21 and a second internal electrode layer 22 adjacent to the first internal electrode layer 21. In this specification, the first internal electrode layers 21 and the second internal electrode layers 22 may be referred to collectively as “the internal electrode layers” when it is not necessary to distinguish the first internal electrode layers 21 and the second internal electrode layers 22 from each other.

In the illustrated embodiment, the body 10 is constituted by the dielectric layers 11, the first internal electrode layers 21, and the second internal electrode layers 22 stacked together along the T-axis direction. Therefore, the T-axis direction may be referred to as the lamination direction. An upper cover layer 12 may be provided on the top surface of the laminate. A lower cover layer 13 may be provided on the bottom surface of the laminate. The upper cover layer 12 and the lower cover layer 13 may be formed of the same material as the dielectric layers 11. The upper cover layer 12 and the lower cover layer 13 may be a part of the body 10.

Each of the first internal electrode layers 21 has one end led toward the outside of the body 10. The first internal electrode layer 21 is connected to the first external electrode 31 provided on the surface of the body 10. Each of the second internal electrode layers 22 has one end led toward the outside of the body 10. The second internal electrode layer 22 is connected to the second external electrode 32 provided on the surface of the body 10. In the illustrated embodiment, the first internal electrode layer 21 is led from one end in the L-axis direction toward the outside of the body 10. The first internal electrode layer 21 is connected to the first external electrode 31 at one end of the body 10 in the L-axis direction. The second internal electrode layer 22 is led from the other end in the L-axis direction toward the outside of the body 10. The second internal electrode layer 22 is connected to the second external electrode 32 at the other end of the body 10 in the L-axis direction. In the example shown in FIG. 2, the first and second internal electrode layers 21 and 22 are respectively led out to the first and second end surfaces 10c and 10d, which are opposed to each other, but the first and second internal electrode layers 21 and 22 can be led out through various surfaces of the body 10 in accordance with the locations and the shapes of the first and second external electrodes 31 and 32. For example, if both the first and second external electrodes 31 and 32 are located on the bottom surface 10b, both the first and second internal electrode layers 21 and 22 are led out through the bottom surface. The first and second external electrodes 31 and 32 may be located on any of the surfaces of the body 10 as long as they are separated from each other.

When voltage is applied between the first and second external electrodes 31 and 32, capacitance is generated between the first and second internal electrode layers 21 and 22.

FIG. 2 shows five each of the first and second internal electrode layers 21 and 22 for simplicity of illustration, but the laminated ceramic capacitor 1 may include any number of layers stacked together. The laminated ceramic capacitor 1 may include, for example, 300 to 1000 first internal electrode layers 21 and the same number of second internal electrode layers 22. In other words, the number of stacked layers in the laminated ceramic capacitor 1 may be 300 to 1000.

The laminated ceramic capacitor 1 may be mounted on an electronic circuit board. The electronic circuit board having the laminated ceramic capacitor 1 mounted thereon may be referred to as a circuit module. Various electronic components other than the laminated ceramic capacitor 1 may also be mounted on the circuit module. The circuit module may be installed in various electronic devices. The electronic devices in which the circuit module can be installed include smartphones, tablets, game consoles, electrical components of automobiles, servers, and various other electronic devices.

In one aspect, the body 10 may be configured to have a rectangular parallelepiped shape. The term “rectangular parallelepiped” or “rectangular parallelepiped shape” used herein is not intended to mean solely “rectangular parallelepiped” in a mathematically strict sense. As described later, the corners and/or edges of the body 10 may be rounded. The dimensions and the shape of the body 10 are not limited to those specified herein.

In one aspect, the laminated ceramic capacitor 1 has a dimension in the L-axis direction (length) of 0.2 mm to 2.5 mm, a dimension in the W-axis direction (width) of 0.1 mm to 3.5 mm, and a dimension in the T-axis direction (height) of 0.1 mm to 3.0 mm. In one aspect, the length of the laminated ceramic capacitor 1 may be larger than the width thereof. In one aspect, the height of the laminated ceramic capacitor 1 may be larger than the width thereof. In one aspect, the width of the laminated ceramic capacitor 1 may be larger than the length thereof.

### (1-2) Dielectric Layer 11

The dielectric layers 11 contain as their main component an oxide represented by a chemical formula ABO₃. The oxide may have a perovskite structure. A component that is at least 50 wt % of the dielectric layers 11 with reference to the total mass of the dielectric layers 11 can be regarded as the main component of the dielectric layers 11. When the dielectric layers 11 contain 50 wt % or more of the oxide represented by the chemical formula ABO₃, the dielectric layers 11 can be considered to contain the oxide represented by the chemical formula ABO₃ as their main component. The dielectric layers 11 preferably contain at least 60 wt %, 70 wt %, 80 wt %, or 90 wt % of the oxide represented by the chemical formula ABO₃.

In the chemical formula ABO₃, “A” is at least one element selected from the group consisting of Ba (barium), Sr (strontium), Ca (calcium), and Mg (magnesium). In the chemical formula ABO₃, “B” is at least one element selected from the group consisting of Ti (titanium), Zr (zirconium), and Hf (hafnium). When the oxide represented by the chemical formula ABO₃ has a perovskite structure, the elements “A” and “B” are located at the A site and the B site of the perovskite structure, respectively. Examples of the oxide contained in the dielectric layers 11 as their main component include BaTiO₃ (barium titanate), CaZrO₃ (calcium zirconate), CaTiO₃ (calcium titanate), SrTiO₃ (strontium titanate), and MgTiO₃ (magnesium titanate).

The oxide contained in the dielectric layers 11 as the main component may be an oxide represented by the chemical formula Ba_{1-x-y}CaₓSr_{y}Ti_{1-z}Zr_{z}O₃ (0≤x≤1, 0≤y≤1, 0≤z≤1). Examples of this type of oxide include strontium barium titanate, calcium barium titanate, barium zirconate, barium zirconate titanate, calcium zirconate titanate, and calcium barium zirconate titanate.

The dielectric layers 11 may contain one or more additive elements in addition to the main component oxide. In one aspect, the one or more additive elements contained in the dielectric layers 11 are selected from the group consisting of Fe (iron), Ni (nickel), Mo (molybdenum), Nb (niobium), Ta (tantalum), W (tungsten), Mg (magnesium), Mn (manganese), V (vanadium), and Cr (chromium). The dielectric layers 11 may contain two or more of the above additive elements.

The dielectric layers 11 may contain oxides of rare earth elements in addition to the main component oxide. The oxides of rare earth elements contained in the dielectric layers 11 may be oxides of at least one rare earth element selected from the group consisting of Y (yttrium), Sm (samarium), Eu (europium), Gd (gadolinium), Tb (terbium), Dy (dysprosium), Ho (holmium), Er (erbium), Tm (thulium), and Yb (ytterbium). The dielectric layers 11 may contain oxides of two or more rare earth elements.

The dielectric layers 11 may contain yet another type of oxide. The dielectric layers 11 may contain oxides of at least one element selected from the group consisting of, for example, Co (cobalt), Ni (nickel), Li (lithium), B (boron), Na (sodium), K (potassium), and Si (silicon). The dielectric layers 11 may contain oxides of two or more of these elements.

The dielectric layers 11 may contain glass containing at least one element selected from the group consisting of Co, Ni, Li, B, Na, K, and Si.

In one aspect, the thickness (the dimension in the T-axis direction) of each dielectric layer 11 is 0.2 to 10 μm.

### (1-3) First Internal Electrode Layers 21 and Second Internal Electrode Layers 22

In one aspect, the first internal electrode layers 21 contain Ni (nickel) as the main component thereof. A component that is at least 50 wt % of the first internal electrode layers 21 with reference to the total mass of the first internal electrode layers 21 can be regarded as the main component of the first internal electrode layers 21. The first internal electrode layers 21 preferably contain 60 wt % or more, 70 wt % or more, 80 wt % or more, or 90 wt % or more of Ni as the main component thereof.

The first internal electrode layers 21 contain Fe in addition to Ni. The first internal electrode layers 21 may contain at least one element selected from the group consisting of Re (rhenium), In (indium), Sn (tin) and Zn (zinc), in addition to Ni and Fe.

The first internal electrode layers 21 may contain one or more elements selected from the group consisting of As (arsenic), Au (gold), Co, Cr, Cu, Fe, Ir (iridium), Mg, Os (osmium), Pd (palladium), Pt (platinum), Rh (rhodium), Ru (ruthenium), Se (selenium), Ge (germanium), Te (tellurium), W, Y (yttrium), Ag (silver), and Mo, in addition to Ni and Fe.

The description of the components of the first internal electrode layers 21 also applies to the components of the second internal electrode layers 22.

In an aspect, the thickness (the dimension in the T-axis direction) of each first internal electrode layer 21 and the thickness (the dimension in the T-axis direction) of each second internal electrode layer 22 are both 0.1 μm to 2 μm. The description of the thickness of each first internal electrode layer 21 also applies to the thickness of each second internal electrode layer 22.

### (1-4) First External Electrode 31 and Second External Electrode 32

In one aspect, the first and second external electrodes 31 and 32 are formed by applying a conductive paste to the body 10 and heating the conductive paste. The conductive paste can contain at least one substance from the group consisting of Ag, Pd, Au, Pt, Ni, Sn, Cu, W, Ti, and alloys of these.

The first external electrode 31 may include an Ni plated layer. The Ni plating layer can be formed by the electrolytic or electroless plating method on the surface of a base electrode layer that is formed by heating a conductive paste. Similarly, the second external electrode 32 can also include an Ni plating layer.

### (1-5) Intermediate Layer

An intermediate layer containing Fe may be provided between the dielectric layer 11 and the first internal electrode layer 21, and/or between the dielectric layer 11 and the second internal electrode layer 22. The intermediate layer may contain Fe in a higher concentration than the first and second internal electrode layers 21 and 22. The intermediate layer can increase the height of the Schottky barrier formed between the dielectric layer 11 and the first internal electrode layer 21, and/or the height of the Schottky barrier formed between the dielectric layer 11 and the second internal electrode layer 22. The increase in the height of the Schottky barrier formed between the dielectric layer 11 and the first internal electrode layer 21 and/or between the dielectric layer 11 and the second internal electrode layer 22 can lead to improvement of the insulation reliability of the laminated ceramic capacitor. The thickness (dimension in the T-axis direction) of the intermediate layer is, for example, 0.2 nm to 3.0 nm.

### (1-6) Concentration Distribution

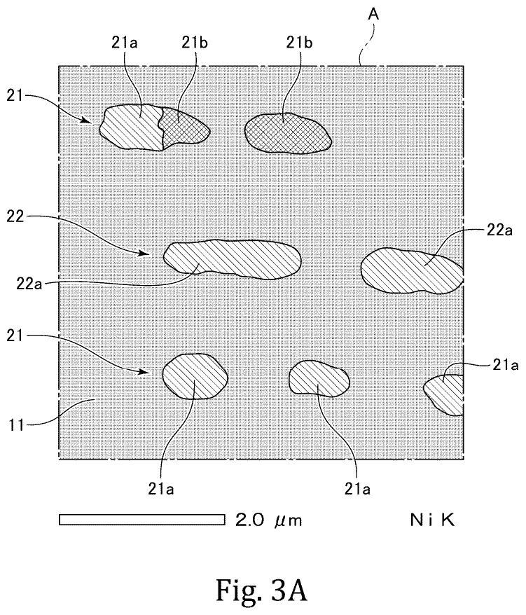

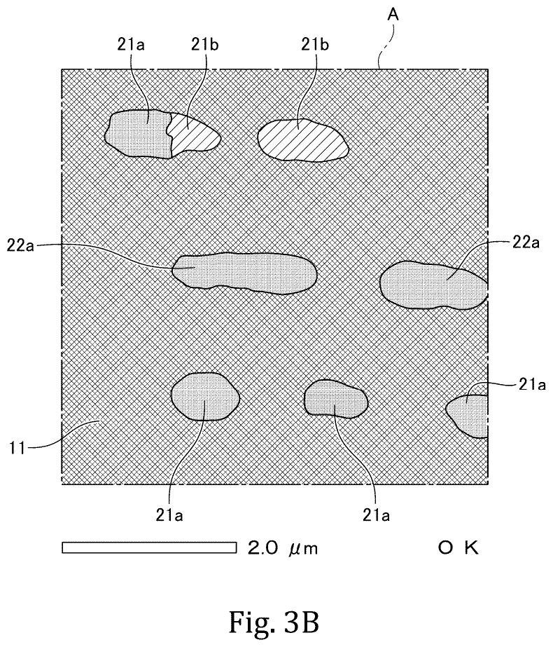

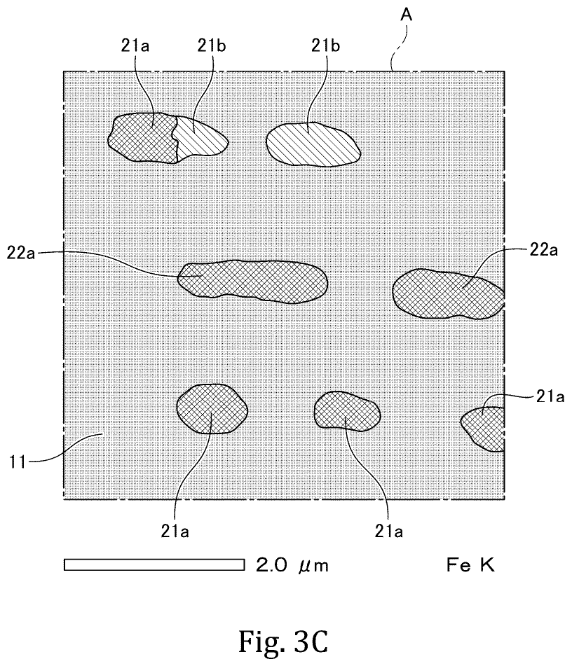

The following now describes the nickel (Ni), iron (Fe) and oxygen (O) concentration distributions in the body 10 with reference to FIGS. 3A to 3C. FIGS. 3A to 3C schematically show the Ni, O and Fe distributions in the region A of the section shown n in FIG. 2, respectively. The concentrations of the elements contained in the body 10 can be quantified by STEM (Scanning Transmission Electron Microscope)-EDS (Energy Dispersive X-ray Spectroscope), TEM (Transmission Electron Microscope)-EDS, 3DAP (3 Dimensional Atom Probe), SIMS (Secondary Ion Mass Spectrometry), or other known analytical methods. The concentration distributions shown in FIGS. 3A to 3C are based on the concentration maps obtained by performing STEM-EDS analysis on the surface exposed by cutting an actually fabricated laminated ceramic capacitor 1 along the LT plane.

Since nickel (Ni) is the main component metal of the first and second internal electrode layers 21 and 22, the Ni concentration is high inside the first and second internal electrode layers 21 and 22. On the other hand, Ni is virtually absent in the dielectric layers 11.

In one aspect, each first internal electrode layer 21 is partitioned into a first region 21a with a relatively high Ni concentration and a second region 21b with a relatively low Ni concentration. The Ni concentration is lower in the second region 21b than in the first region 21a.

Oxygen (O) is contained in the oxide (e.g., BaTiO₃) that is the main component of the dielectric layer. For this reason, the O concentration is high in the dielectric layer 11 and low in the first and second internal electrode layers 21 and 22. In the second region 21b of the first internal electrode layer 21, however, the O concentration is high. According to one aspect, the O concentration in the second region 21b of the first internal electrode layer 21 is higher than that in the first region 21a. The first internal electrode layer 21 hardly contains O in the first region 21a. The O concentration in the first region 21a may be below the detection limit of STEM-EDS (e.g., 0.01 at %). Therefore, the Ni contained in the first region 21a is scarcely or not oxidized at all. The O concentration in the second region 21b of the first internal electrode layer 21 may be higher than that in the dielectric layer 11.

Fe is contained in the first and second internal electrode layers 21 and 22 as the secondary element Fe may be contained in the dielectric layer 11. The Fe is derived from the Fe-containing powder mixed in the raw materials for the internal electrode layers and/or the dielectric layer 11. The Fe added to the raw materials may be thermally diffused during the manufacturing process and be present in both the internal electrode layers and the dielectric layer 11.

According to one aspect, the Fe is locally concentrated in the second region 21b of the first internal electrode layer 21. In other words, the Fe is contained in the second region 21b of the first internal electrode layer 21 at a higher concentration than in the other regions. For example, the Fe concentration is higher in the second region 21b than in the first region 21a. The Fe concentration in the second region 21b may be higher than the Ni concentration in the second region 21b.

The second region 21b is formed, for example, through oxidation of Ni contained in the precursor of the first internal electrode layer 21 or the first internal electrode layer 21 that takes place when the laminate containing the precursor of the first internal electrode layer 21 or the fired body obtained by firing the laminate is heated during the manufacturing process of the laminated ceramic capacitor 1. Therefore, the O concentration in the second region 21b is significantly higher than that in the first region 21a, where Ni is scarcely or no oxidized at all. The standard Gibbs energy of formation of Ni oxides is close to that of Fe oxides (magnetite (Fe₃O₄)). Therefore, when the Ni is oxidized into nickel oxide, the Fe present around the Ni is also oxidized into magnetite. For this reason, the second region 21b also contains oxides of Fe (magnetite (Fe₃O₄)). The standard Gibbs energies of formation of oxides can be found in thermodynamic databases such as the “Thermodynamic database for nuclear fuels and reactor materials”. In the second region 21b, hematite (Fe₂O₃) may also possibly be formed through oxidation of Fe. However, since the standard Gibbs energy of formation of nickel oxide is close to that of magnetite, more magnetite is produced than hematite in the second region 21b. Therefore, the content ratio of magnetite in the second region 21b is higher than that of hematite.

The Fe concentration is higher in the second region 21b than in the first region 21a for the following reasons. Since the second region 21b is the region where the Ni is oxidized into nickel oxide during the manufacturing process, the second region 21b also undergoes formation of Fe oxide (Fe₃O₄) from Fe. Specifically, Fe is more stable as an oxide than in the form of a metallic element in the second region 21b. Therefore, the Fe present in the form of a metallic element in the first internal electrode layer 21 tends to segregate into the second region 21b to form a more stable oxide. In this way, an Fe oxide (Fe₃O₄) is formed in the second region 21b. In other words, the Fe in the first internal electrode layer 21 segregates into the second region 21b as it tends to transform into a more stable oxide state. This results in a higher Fe concentration in the second region 21b than in the other regions (the first region 21a).

As discussed above, the second region 21b of the first internal electrode layer 21, where the O concentration is high, has a lower Ni concentration and a higher Fe concentration than the first region 21a. Therefore, the second region 21b undergoes formation of not only electrically insulating nickel oxide but also electrically conductive magnetite. Due to the magnetite formed in the second region 21b, capacitance can be produced between the second internal electrode layer 22 and the second region 21b that face each other in the T-axis direction upon application of voltage between the first and second external electrodes 31 and 32.

Conventional laminated ceramic capacitors do not have a region corresponding to the second region 21b. Therefore, oxidation in the first internal electrode layer 21 may produce agglomerates of nickel oxide. The portion of the first internal electrode layer 21 where the nickel oxide agglomerates are formed cannot function as the electrode when voltage is applied between the first and second external electrodes 31 and 32. The conventional laminated ceramic capacitors suffer from a decrease in capacitance if the Ni in the internal electrode layers is oxidized. In one aspect of the present invention, on the other hand, the first internal electrode layer 21 has the second region 21b with high Fe and O concentrations, thereby preventing the decrease in capacitance that is caused by the oxidation of the Ni.

According to one aspect, the Fe concentration in the second region 21b may be higher than the Ni concentration in the second region 21b. This can lead to a further decrease in insulation resistance of the second region 21b, which allows increased capacitance to be produced between the second region 21b and the second internal electrode layer 22 that face each other in the T-axis direction. Since the Fe concentration is higher than the Ni concentration in the second region 21b, the decrease in capacitance that is attributable to the oxidation of the Ni in the first internal electrode layer 21 can be further reduced.

The Fe concentration represents the atomic ratio (at %) of Fe with respect to Ni, assuming Ni is 100 at %. Likewise, the O concentration indicates the atomic ratio (at %) of O with respect to Ni, assuming Ni is 100 at %. As used herein, the Fe and O concentrations are expressed in the atomic ratio with respect to Ni when Ni accounts for 100 at %, unless otherwise specified.

In one aspect, the second region 21b contains at least one of Sn or Zn, in addition to Ni, Fe, and O. When the second region 21b contains Sn, the Sn concentration is higher in the second region 21b than in the first region 21a. When the second region 21b contains Zn, the Zn concentration is higher in the second region 21b than in the first region 21a. The standard Gibbs energies of formation of Sn and Zn oxides are lower than that of Ni oxides. Therefore, when the Ni is oxidized into nickel oxide in the second region 21b, the Sn and Zn existing around the Ni also tend to be oxidized into Sn and Zn oxides. Since the Sn and Zn oxides are both electrically conductive, the Sn and Zn oxides formed in the second region 21b can lead to generation of capacitance between the second internal electrode layer 22 and a larger portion of the second region 21b that face each other upon application of voltage between the first and second external electrodes 31 and 32. For the above reasons, the higher Sn concentration in the second region 21b than in the first region 21a can further reduce the decrease in capacitance that is caused by the oxidation of the Ni in the first internal electrode layer 21. Likewise, since the Zn concentration is higher in the second region 21b than in the first region 21a, the decrease in capacitance that is caused by the oxidation of the Ni in the first internal electrode layer 21 can be further reduced. There are other elements that have similar effects to those of Sn and Zn. Such elements include Re and In. Like Sn and Zn, the second region 21b contains at least one of Re or In. When the second region 21b contains Re, the Re concentration is higher in the second region 21b than in the first region 21a. When the second region 21b contains In, the In concentration is higher in the second region 21b than in the first region 21a.

The first internal electrode layer 21 may have a third region, which is not shown, in addition to the first and second regions 21a and 21b. The third region is a different region from the first and second regions 21a and 21b. In other words, the third region does not overlap with the first and second regions 21a and 21b. The third region has a lower Ni concentration than the first region 21a. The third region contains at least one of Sn or Zn, in addition to Ni and O described above. The O concentration may be higher in the third region than in the first region 21a. In the third region, when the Ni is oxidized into nickel oxide, the Sn and Zn existing around the Ni is also oxidized into Sn and Zn oxides. Since the Sn and Zn oxides are electrically conductive, the Sn and Zn oxides formed in the third region 21b can lead to generation of capacitance between the third region and the second internal electrode layer 22. For the above reasons, setting the O concentration higher in the third region than in the first region 21a and setting the Sn concentration higher in the third region than in the first region 21a can reduce the decrease in capacitance that is caused by the oxidation of the Ni in the first internal electrode layer 21. Likewise, setting the O concentration higher in the third region than in the first region 21a and setting the Zn concentration higher in the third region than in the first region 21a can reduce the decrease in capacitance that is caused by the oxidation of the Ni in the first internal electrode layer 21. There are other elements that have similar effects to those of Sn and Zn. Such elements include Re and In. Like Sn and Zn, the third region contains at least one of Re or In.

In the sections shown in FIGS. 3A to 3C, the second internal electrode layer 22 has a first region 22a. In one aspect, the second internal electrode layer 22 may have, in addition to the first region 22a, a second region with higher Fe and O concentrations than the first region 22a. Specifically, the second internal electrode layer 22 may have a region that corresponds to the second region 21b of the first internal electrode layer 21. The foregoing description of the first and second regions 21a and 21b of the first internal electrode layer 21 also applies to the first region 22a and second region of the second internal electrode layer 22.

### (2) Manufacturing Method of Laminated Ceramic Capacitor 1

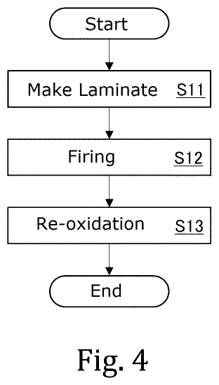

A description will now be given of one example of the manufacturing method of the laminated ceramic capacitor 1 with reference to FIG. 4. FIG. 4 is a flowchart showing a flow of a manufacturing method of a capacitor according to one embodiment of the disclosure.

A brief description is given of the manufacturing method shown in FIG. 4. To begin with, in the step S11, a laminate is formed as the precursor of the body 10. The laminate includes dielectric green sheets, which are the precursor of the dielectric layers 11, and internal electrode patterns, which are the precursor of the first and second internal electrode layers 21 and 22. The internal electrode patterns contain Ni and Fe. The laminate is then fired in the step S12 into a fired body. Subsequently, in the step S13, the fired body is subjected to re-oxidization, to be processed into the laminated ceramic capacitor 1.

The following describes each of the steps shown in FIG. 4 in more detail. First, in the step S11, dielectric powder is wet-mixed with a binder such as polyvinyl butyral (PVB) resin, an organic solvent such as ethanol or toluene, and a plasticizer to obtain a slurry. This slurry is coated on a substrate film using, for example, the die coater or doctor blade method, and then the slurry coated on the substrate film is dried, to obtain a dielectric green sheet. The dielectric green sheets are the precursor of the dielectric layers 11.

The dielectric powder used as the raw powder of the dielectric green sheets is, for example, barium titanate powder. Barium titanate powder is synthesized by reacting titanium raw material such as titanium dioxide with barium raw material such as barium carbonate by a known method such as the solid phase method, the sol-gel method, or the hydrothermal method.

Next, an internal electrode pattern is formed on each of the dielectric green sheets formed as described above. The internal electrode pattern is formed, for example, by printing a paste for the internal electrodes on the dielectric green sheet using screen printing or other known printing methods. When the internal electrode patterns are formed by screen printing, the paste for the internal electrodes is produced by kneading and mixing a metal powder, a binder resin, and a solvent by a three-roll mill. In other words, the paste for the internal electrodes is a binder resin containing a metal powder dispersed therein. The metal powder contained in the paste for the internal electrodes may be a powder mixture produced by mixing Ni powder, which is the main component of the first and second internal electrode layers 21 and 22, with an Fe-containing powder, which contains Fe. The Fe-containing powder is, for example, Fe₂O₃ powder. The Fe-containing powder is weighed such that the ratio of Fe to 100 at % of Ni is 0.02 to 4.0 at % and the weighed Fe-containing powder is mixed with the Ni powder.

The organic binder used in the paste for the internal electrodes may be a cellulose-based resin such as ethyl cellulose or an acrylic resin such as butyl methacrylate. The internal electrode patterns formed on some of the dielectric green sheets are the precursor of the first internal electrode layers 21, and the internal electrode patterns formed on the others of the dielectric green sheets are the precursor of the second internal electrode layers 22.

The method of forming the internal electrode pattern is not limited to that specified herein. The internal electrode pattern may be formed by various known methods, e.g., sputtering, vacuum deposition, PLD (pulsed laser deposition), MO-CVD (metal organic chemical vapor deposition), MOD (metal organic decomposition), or CSD (chemical solution deposition).

As described above, a lamination unit having a dielectric green sheet and an internal electrode pattern formed on the surface of the dielectric green sheet is obtained. A predetermined number of lamination units are stacked together and thermo-compressed to form a laminate. The top layer and the bottom layer of the laminate may be formed of green sheets that do not have internal electrode patterns formed thereon.

Next, the laminate is diced into pieces to obtain chip-like laminates each being the precursor of the body 10. The chip-like laminates may be subjected to a degreasing process. The degreasing process may be performed in an N₂ atmosphere. The laminates having undergone the degreasing process may be coated with a metal paste by the dip method to form base electrode layers for the first and second external electrodes 31 and 32.

Next, in the step S12, the chip laminate produced in the step S11 is placed into a firing furnace and fired in accordance with a predetermined temperature profile. In the firing furnace, a low oxygen atmosphere with an oxygen partial pressure of 10⁻¹² to 10⁻¹⁰ atm is maintained, for example. In the step S12, the temperature in the firing furnace is first raised from the room temperature to a firing start temperature at the rate of 200 to 1000° C./h and kept at the firing start temperature for 10 minutes to one hour. In other words, in the step S12, the chip laminate is heated at the firing start temperature for 10 minutes to one hour. The firing start temperature is set at 850 to 1100° C. where Ni can be sintered. The temperature in the firing furnace is then increased at a fast rate from the firing start temperature to a firing top temperature. The firing top temperature is, for example, 1150 to 1300° C. The temperature increase rate is, for example, 3000 to 10000° C./h. The temperature in the firing furnace is then kept at the firing top temperature for 10 to 30 minutes, and subsequently lowered. In the above-described manner, the chip laminate is fired into a fired body.

After this, the step S13 performs re-oxidation on the fired body fabricated in the step S12. In the fired body, the oxide contained in the dielectric layers 11 (according to the above example, BaTiO₃) has oxygen defects. Therefore, the re-oxidation is performed to heat the fired body in an atmosphere with an oxygen partial pressure higher than in the atmosphere for the firing. In one aspect, the re-oxidation of the step S13 heats the fired body at a temperature of 800 to 1000° C. for a duration of 30 minutes to 2 hours in an atmosphere with an oxygen partial pressure of 10⁻⁴ to 10⁻⁷ atm. In one aspect, the re-oxidation of the step S13 may be performed in an atmosphere with an oxygen partial pressure of 10⁻⁴ to 10⁻⁶ atm. In the conventional art, re-oxidation is performed in a low oxygen atmosphere of about 10⁻⁸ to 10⁻⁹ to prevent oxidation of Ni. According to one aspect of the present invention, on the other hand, the re-oxidation may be performed with an oxygen partial pressure of 10⁻⁴ to 10⁻⁶ atm, which is higher than in the conventional art. The decrease in capacitance of the laminated ceramic capacitor can be still prevented since Ni is oxidized in a partial region of the internal electrode layers but Fe is also oxidized in the same partial region into magnetite, which is electrically conductive. For this reason, the step S13 involves performing re-oxidation with an oxygen partial pressure in the range of 10⁻⁴ to 10⁻⁶ atm, which is higher than in the conventional art. Since the re-oxidation is performed in an atmosphere with a higher oxygen partial pressure than in the conventional art, oxygen can be more readily fed to the oxygen defects in the dielectric layers than in the conventional art. This can result in reducing the time required for the re-oxidation.

In the above-described manner, the laminated ceramic capacitor 1 can be completed.

Processes not shown in the flowchart of FIG. 4 may be performed to produce the laminated ceramic capacitor 1. For example, a Ni plating layer may be formed on the surface of the base electrode layers of the fired body after undergoing the re-oxidation. The Ni plating layer can be formed by the electrolytic or electroless plating method. A Sn plating layer may be formed on the surface of the base electrode layers, in addition to the Ni plating layer.

The metal powder in the paste for the internal electrodes may be produced by mixing the Ni powder and the Fe-containing powder additionally with powder containing at least one of Sn or Zn. The metal powder in the paste for the internal electrodes may be produced by additionally mixing powder containing at least one of Re or In.

### (3) Verification of Generation of Second Area 21b in Samples

A 1005-size laminated ceramic capacitor 1 constituted by 10 stacked layers was fabricated according to the manufacturing method shown in FIG. 4. To fabricate the laminated ceramic capacitor 1, the paste for the internal electrodes was made from a powder mixture of Ni powder and Fe₂O₃ powder, which was weighed in the proportion of 1.0 at % Fe relative to 100 at % Ni. One hundred pieces were selected from the fabricated laminated ceramic capacitors 1. For each of the 100 selected pieces, the generation of the second region 21b was verified as follows. Each piece was processed into a thin slice using a focused ion beam (FIB) system so that the LT surface can be used as the observation surface, so that a sliced analysis specimen with a thickness of 60 nm was taken from each piece. Damage that appeared on the observation surface of the sliced specimen was removed by Ar ion milling. Subsequently, the sliced analysis specimen was placed in a TEM equipped with an EDS detector, and multiple observation areas of 5 μm square (corresponding to the region A in FIG. 2) were set on the observation surface of the sliced analysis specimen. The multiple observation areas were each subjected to EDS analysis. Specifically, concentration maps were obtained for each of the multiple observation areas, representing the concentrations of the quantitative elements (Ni, Fe, and O) in atomic ratio (at %). The concentration maps obtained in this way for the respective pieces were examined. It was verified that the Fe and O concentrations were higher in some regions of the internal electrode layers than in the other regions of the internal electrode layers, and that the Ni concentration was lower in these regions than in the other regions of the internal electrode layers. Stated differently, it was confirmed that each piece had the second region 21b in a portion of the internal electrode layers within the observation areas.

The atomic ratio of Fe²⁺ to the total amount of Fe²⁺ and Fe³⁺ contained in the region of the observation surface of each analysis specimen that corresponds to the second region 21b (hereinafter also referred to as the “Fe²⁺ content ratio”) was evaluated by X-ray Absorption Fine Structure (XAFS) analysis. Specifically, an XAFS spectrum was measured for the region of the observation surface of each piece that corresponds to the second region 21b, and the X-ray absorption near edge structure (XANES) spectrum of the XAFS spectrum was obtained. In the XANES spectrum, the peak located at 7008-7012 eV was identified as the Fe²⁺ peak, and its peak area was calculated. Similarly, the peak located at 7013-7016 eV was identified as the Fe³⁺ peak, and its peak area was calculated. The peak area of Fe²⁺ represents the atomic percentage (at %) of Fe²⁺ present in the evaluation region of the section of each piece, while the peak area of Fe³⁺ represents the atomic percentage (at %) of Fe³⁺ present in the same region. Therefore, the Fe²⁺ content ratio can be expressed based on the peak areas of Fe²⁺ and Fe³⁺ by the following formula (1).

$${Fe}^{2 +} content ratio = ( {Fe}^{2 +} peak area ) / \{ ( {Fe}^{2 +} peak area ) + ( {Fe}^{3 +} peak area ) \}$$

The Fe²⁺ content ratio calculated by the above formula (1) for each piece ranged from 0.30 to 0.37. Fe₃O₄ contains twice as much Fe³⁺ as Fe²⁺, in atomic ratio. In other words, the atomic ratio of Fe²⁺ to Fe³⁺ in Fe₃O₄ (that is, Fe²⁺/Fe³⁺) is 1/2. This means that the atomic ratio of Fe²⁺ to the total amount of Fe²⁺+Fe³⁺ is approximately 0.33 for Fe₃O₄. As mentioned above, the Fe²⁺ content ratio in the second region 21b is in the range of 0.3 to 0.37 for the fabricated pieces. Therefore, the iron oxide contained in the second region 21b is presumed to be primarily magnetite.

### (4) Capacitance of Samples

The manufacturing method shown in FIG. 4 was employed to fabricate a laminated ceramic capacitor 1 as an implementation example of the present invention. In addition, another laminated ceramic capacitor was also fabricated as a comparative example in the following manner. The internal electrode paste prepared to fabricate a laminated ceramic capacitor as a comparative example used Ni powder as the metal powder instead of a powder mixture of Ni powder and Fe-containing powder. The comparative example laminated ceramic capacitor was fabricated under the same conditions as the implementation example laminated ceramic capacitor 1, except that Ni powder was used instead of the powder mixture as the metal powder for the internal electrode paste. The comparative example laminated ceramic capacitor differs from the implementation example laminated ceramic capacitor 1 in that Fe is not added to the raw material and thus not contained in the internal electrode layers.

One hundred pieces were selected for each of the comparative and implementation examples, and the capacitance was measured for each piece. The capacitance was measured using an LCR meter with a measurement voltage of 0.5 V and a frequency of 1 kHz. The average of the measured values was taken as the capacitance of each sample. The capacitance thus calculated was 90 nF for the implementation example and 85 nF for the comparative example. The capacitance of the implementation example was about 5% higher than that of the comparative example. The reason why the implementation example achieved higher capacitance than the comparative example can be explained as follows. In the comparative example, Ni was oxidized in some regions of the internal electrode layers during the re-oxidation process, and the oxidized regions did not function as the electrode. Whereas in the implementation example, Fe was also oxidized in the second area 21b, where Ni was oxidized, to form magnetite. The decrease in capacitance that is caused by the oxidation of Ni in the internal electrode layers was compensated for by the second region 21b containing the magnetite, which is electrically conductive.

### (5) Notes

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

The expression of “including” a constituent element used herein does not exclude other constituent elements but rather means that other constituent elements can be further included, as long as they are consistent with the invention.

### (6) Additional Embodiments

Embodiments disclosed herein also include the following.

### Additional Embodiment 1

A laminated ceramic capacitor including:
a body having a first internal electrode layer, a second internal electrode layer, and a dielectric layer, the first and second internal electrode layers being principally formed of Ni, the dielectric layer being disposed between the first internal electrode layer and the second internal electrode layer;
a first external electrode provided on the body so as to be electrically connected to the first internal electrode layer; and
a second external electrode provided on the body so as to be electrically connected to the second internal electrode layer,
wherein the first internal electrode layer includes a first region and a second region,
wherein the second region has a lower Ni concentration than the first region,
wherein the second region has a higher Fe concentration than the first region, and
wherein the second region has a higher O concentration than the first region.

### Additional Embodiment 2

The laminated ceramic capacitor of [Additional Embodiment 1], wherein the Fe concentration in the second region is higher than the Ni concentration in the first region.

### Additional Embodiment 3

The laminated ceramic capacitor of [Additional Embodiment 1] or [Additional Embodiment 2], wherein a magnetite content ratio is higher than a hematite content ratio in the second region.

### Additional Embodiment 4

The laminated ceramic capacitor of any one of [Additional Embodiment 1] to [Additional Embodiment 3], wherein the second region has a higher Sn concentration than the first region.

### Additional Embodiment 5

The laminated ceramic capacitor of any one of [Additional Embodiment 1] to [Additional Embodiment 4], wherein the second region has a higher Zn concentration than the first region.

### Additional Embodiment 6

The laminated ceramic capacitor of any one of [Additional Embodiment 1] to [Additional Embodiment 5],
wherein the first internal electrode layer further includes a third region,
wherein the third region has a higher Sn concentration than the first region, and
wherein the third region has a higher O concentration than the first region.

### Additional Embodiment 7

The laminated ceramic capacitor of any one of [Additional Embodiment 1] to [Additional Embodiment 6],
wherein the first internal electrode layer further includes a third region,
wherein the third region has a higher Zn concentration than the first region, and
wherein the third region has a higher O concentration than the first region.

### Additional Embodiment 8

A circuit module including the laminated ceramic capacitor of any one of [Additional Embodiment 1] to [Additional Embodiment 7].

### Additional Embodiment 9

An electronic device including the circuit module of [Additional Embodiment 8].

### Additional Embodiment 10

A method of manufacturing a laminated ceramic capacitor, the method including:
preparing a laminate including a dielectric green sheet and an internal electrode pattern, the internal electrode pattern containing Ni and Fe;
firing the laminate into a fired body; and
performing re-oxidation by heating the fired body with an oxygen partial pressure of 10⁻⁴ to 10⁻⁷ atm.

What is claimed is:

1. A laminated ceramic capacitor comprising:
a body having a first internal electrode layer, a second internal electrode layer, and a dielectric layer, the first and second internal electrode layers being principally formed of Ni, the dielectric layer being disposed between the first internal electrode layer and the second internal electrode layer;
a first external electrode provided on the body so as to be electrically connected to the first internal electrode layer; and
a second external electrode provided on the body so as to be electrically connected to the second internal electrode layer,
wherein the first internal electrode layer includes a first region and a second region,
wherein the second region has a lower Ni concentration than the first region,
wherein the second region has a higher Fe concentration than the first region, and
wherein the second region has a higher O concentration than the first region.

2. The laminated ceramic capacitor of claim 1, wherein the Fe concentration in the second region is higher than the Ni concentration in the first region.

3. The laminated ceramic capacitor of claim 1, wherein a magnetite content ratio is higher than a hematite content ratio in the second region.

4. The laminated ceramic capacitor of claim 1, wherein the second region has a higher Sn concentration than the first region.

5. The laminated ceramic capacitor of claim 1, wherein the second region has a higher Zn concentration than the first region.

6. The laminated ceramic capacitor of claim 1,
wherein the first internal electrode layer further includes a third region,
wherein the third region has a higher Sn concentration than the first region, and
wherein the third region has a higher O concentration than the first region.

7. The laminated ceramic capacitor of claim 1,
wherein the first internal electrode layer further includes a third region,
wherein the third region has a higher Zn concentration than the first region, and
wherein the third region has a higher O concentration than the first region.

8. A circuit module comprising the laminated ceramic capacitor of claim 1.

9. An electronic device comprising the circuit module of claim 8.

10. A method of manufacturing a laminated ceramic capacitor, the method comprising:
preparing a laminate including a dielectric green sheet and an internal electrode pattern, the internal electrode pattern containing Ni and Fe;
firing the laminate into a fired body; and
performing re-oxidation by heating the fired body with an oxygen partial pressure of 10⁻⁴ to 10⁻⁷ atm.
